(19) United States
(12) Patent Application Publication
(10) Pub. No.: US 2021/0244175 A1
(43) Pub. Date: Aug. 12, 2021

(54) Method of manufacturing a paint brush head

(71) Applicant: ORKLA HOUSE CARE AB, Bankeryd (SE)

(72) Inventor: Kare JOHANSSON, Fristad (SE)

(21) Appl. No.: 16/973,480

(22) PCT Filed: Jun. 4, 2019
(86) PCT No.: PCT/SE2019/050520

§ 371 Date: Dec. 9, 2020

(30) Foreign Application Priority Data
Jun. 11, 2018 (SE) 1850708-7

(51) Int. Cl. A46D 3/04; B29C 65/16; B29C 65/48; B29C 65/52; B29C 65/00; A46B 3/06; A46B 3/12

(52) U.S. Cl. CPC A46D 3/045; B29L 2031/42; B29C 65/4815; B29C 65/527; B29C 66/02245; B29C 66/30322; B29C 66/534; B29C 66/69; B29C 66/71; B29C 66/7212; B29C 66/7392; B29C 66/7422; B29C 66/74283; A46B 3/06; A46B 3/12; B29C 65/1648

(57) ABSTRACT

A method of manufacturing a paint brush head comprising a bundle of bristles comprising synthetic bristles and a ferrule, a paint brush head manufactured according to the method and a paint brush comprising a paint brush head, The method comprising gathering a number of bristles comprising synthetic bristles into a bundle of bristles such that the bristles are tangent to each other along their length, aligning the bristles of the bundle of bristles at a first end of the bristles obtaining a flush end surface of the bundle of bristles, arranging the first end of the bristles in the ferrule, applying a thermoplastic adhesive in the ferrule at the flush end surface, fusing the first ends of the bristles at the flush end surface together by heat into a jointed bundle of bristles, and fusing the thermoplastic adhesive in the ferrule by means of the laser to connect the thermoplastic adhesive to the jointed bundle of bristles and the ferrule.

### TECHNICAL FIELD OF THE INVENTION

The present invention relates to a method of manufacturing a paint brush head comprising comprising a bundle of bristles comprising synthetic bristles and a ferrule, a paint brush head manufactured according to the method and a paint brush comprising such a paint brush head.

### TECHNICAL BACKGROUND

Paint brushes are usually made of a paint brush head that is connected to a paint brush handle. The paint brush head comprise a bundle of bristles connected to a ferrule. The bundle of bristles comprising bristles and the bundle of bristles is able to hold therein a paint by adhesion as well as by capillary forces.

Bristles may be natural or synthetic filaments, wherein synthetic filaments, i.e. monofilaments, can be produced from a wide variety of thermoplastic polymers, in a wide variety of configurations including solid and hollow, and in a wide variety of cross-sections.

It is commonly known to use a metal ferrule and an epoxy adhesive for connecting the bristles to become a bundle of bristles and at the same time the bristle bundle to the ferrule. This is conventionally done by bundling a number of bristles in to a bundle of bristles, inserting one end of the bundle of bristles into the ferrule and then applying the epoxy adhesive against the end of the bristle pack inside the ferrule. The epoxy adhesive sticks to the bristles and connects the bristles in the bundle of bristles to each other so that no bristles will come off during painting. The epoxy adhesive will at the same time float into a groove in the ferrule and mechanically connect the bundle of bristles to the ferrule as the epoxy adhesive cures. It is commonly known that epoxy resins in their liquid and uncured state are mostly classed as irritant to the eyes and skin, as well as toxic to aquatic organisms. Exposure to epoxy resins can, over time, induce an allergic reaction. Sensitization generally occurs due to repeated exposure (e.g. through poor working hygiene and/or lack of protective equipment) over a long period of time.

Furthermore the epoxy adhesives used for paint brush head manufacturing is known to have a long curing time, usually several hours.

The above description of various known aspects is the applicant's characterization of such, and is not an admission that any of the above description is considered as prior art.

### SUMMARY OF THE INVENTION

It is an object of certain aspects of the present invention to provide an improvement over the above described techniques and known art; particularly, achieve an alternative method of manufacturing a paint brush head and to connect the bristles to each other in the bundle of bristles and to connect the bundle of bristles to the ferrule without the use of an epoxy adhesive.

It is, accordingly, an object of the present invention to overcome deficiencies of the prior art, such as indicated above.

It is another object to provide an alternative method of manufacturing a paint brush head without exposing the manufacturing staff to toxic adhesives.

It is yet another object to provide an alternative method of bundling bristles to be used in paint brushes, wherein the overall manufacturing time is reduced.

Still another object is to provide an alternative method of manufacturing a paint brush head, wherein the bundle of bristles is connected to ferrule without the need of a groove in the ferrule.

It is even yet another object to provide an alternative method of manufacturing a paint brush head, wherein the bundle of bristles is glued to the ferrule.

It is an object of at least certain embodiments and aspects of the present invention to provide an improvement over the above described techniques and known art.

At least some of these and other objects and advantages that will be apparent from the description have been achieved by a method of manufacturing a paint brush head comprising a bundle of bristles comprising synthetic bristles and a ferrule, comprising gathering a number of bristles comprising synthetic bristles into a bundle of bristles such that the bristles are tangent to each other along their length, aligning the bristles of the bundle of bristles at a first end of the bristles obtaining a flush end surface of the bundle of bristles, arranging the first end of the bristles in the ferrule, applying a thermoplastic adhesive in the ferrule at the flush end surface, fusing the first ends of the bristles at the flush end surface together by heat into a jointed bundle of bristles, and fusing the thermoplastic adhesive in the ferrule by means of the laser to connect the thermoplastic adhesive to the jointed bundle of bristles and the ferrule.

The method according to the invention achieves that the bundle of bristles can be adhered to the ferrule. By adhering the bristles to the ferrule this opens up for different designs of the ferrule that is not limited to that the bundle of bristles should me mechanically connected in a groove in the ferrule. The connection by adherence is stronger than the mechanical connection according to prior art. Further, a paint brush head can be manufactured without the need of epoxy adhesives. The applicant has realized that a thermoplastic adhesive heated by a laser will obtain better adhesive features and that it can be heated to a higher temperature without damaging the thermoplastic adhesive, than if it is heated to the same temperature by another heat source.

According to an aspect the step of applying the thermoplastic adhesive at the flush end surface in the ferrule, comprise melting the thermoplastic adhesive and thereafter pouring it in the ferrule on to the flush end surface.

According to an aspect the step of applying the thermoplastic adhesive on the flush end surface in the ferrule comprise applying the thermoplastic adhesive in a fixed state in the ferrule on to the flush end surface.

According to an aspect the fixed state of the thermoplastic adhesive is granulates, powder or a mixture thereof.

According to an aspect the step of fusing the thermoplastic adhesive in the ferrule by means of the laser to connect the thermoplastic adhesive to the jointed bundle of bristles and the ferrule comprise heating the thermoplastic adhesive by means of the laser to a temperature higher than its service temperature.

According to an aspect the step of fusing the thermoplastic adhesive in the ferrule by means of the laser to connect the thermoplastic adhesive to the jointed bundle of bristles and the ferrule comprise heating the thermoplastic adhesive by means of the laser to a temperature that is 10-90% higher than its service temperature, preferably 20-80% higher than its service temperature and more preferably 30-80% higher than its service temperature. By service temperature is meant the temperature that the manufacturer of the thermoplastic adhesive recommends that the thermoplastic adhesive is heated to before it is applied to a surface.

According to an aspect the step of fusing the thermoplastic adhesive in the ferrule by means of the laser to connect the thermoplastic adhesive to the jointed bundle of bristles and the ferrule comprise heating the thermoplastic adhesive by means of the laser to a temperature above its boiling temperature.

According to an aspect the method comprise the step of roughening at least a part of an inside of the ferrule before the step of arranging the first end of the bristles in the ferrule.

According to an aspect the step of roughening at least a part of an inside of the ferrule comprise scoaring and/or pickling the at least part of the inside of the ferrule.

According to an aspect the method comprise the step of making a groove on at least a part of an inside of the ferrule before the step of arranging the first end of the bristles in the ferrule.

According to an aspect the thermoplastic adhesive is a hot melt adhesive or hot glue.

According to an aspect the step of fusing the first ends of the bristles at the flush end surface together comprise fusing the first ends of the bristles at the flush end surface by a laser into a jointed bundle of bristles.

According to an aspect the step of fusing the first ends of the bristles at the flush end surface together by means of the laser into a jointed bundle of bristles and the step of fusing the thermoplastic adhesive in the ferrule by means of the laser to connect the thermoplastic adhesive to the jointed bundle of bristles and the ferrule is made in one combined step.

According to an aspect fusing the first ends of the bristles at the flush end surface together by heat into a jointed bundle of bristles is made before the step of arranging the first end of the bristles in the ferrule.

According to an aspect the method comprise arranging one or more inserts in the bundle of bristles.

According to an aspect the ferrule is made of metal, such as steel, stainless steel or aluminium.

According to an aspect the ferrule is made of a thermoplastic material, such as polyamides, polyolefins, polyester, polypropen, or a mix thereof.

According to an aspect the ferrule is made of a heat resistant material, such as a carbon fiber or glassfiber reinforced composite.

According to an aspect the plurality of bristles and/or polymer insert is/are made of a thermoplastic material, such as polyester, polypropen, polyamide or a mix thereof.

According to an aspect the ferrule is heated to a temperature between 30°-90° degrees before arranging the first end of the bristles in the ferrule.

According to an aspect the method comprise the step of melting the thermoplastic adhesive in the ferrule by means of a laser before the step of fusing the thermoplastic adhesive in the ferrule by means of the laser to connect the thermoplastic adhesive to the jointed bundle of bristles and the ferrule.

Further, at least some of these and other objects and advantages that will be apparent from the description have been achieved by a paint brush head manufactured in accordance to the above method.

At least some of the above identified and other objects and advantages that may be apparent from the description have been achieved by a paint brush comprising a paint brush head in accordance with the above.

### BRIEF DESCRIPTION OF THE DRAWINGS

These and other aspects, features and advantages of which embodiments of the invention are capable of, will be apparent and elucidated from the following description of embodiments and aspects of the present invention, reference being made to the accompanying drawings, in which

FIG. 1 shows a paint brush head according to prior art

FIG. 2a shows a side view of a bundle of bristles and a ferrule in an unmounted state of an aspect of the invention.

FIG. 2a shows a 3D view from above of a bundle of bristles and a ferrule in an unmounted state of an aspect of the invention.

FIG. 3a-3d shows a cross sectional side view of a bundle of bristles and a ferrule during manufacturing of an aspect of the invention.

FIG. 4 disclose a cross sectional view of a paint brush head connected to a paint brush handle and comprising an insert.

FIG. 5 a 3D view from below of a bundle of bristles and an insert.

FIG. 6 disclose a flow chart of the steps of manufacturing a paint brush head according to an aspect of the invention.

FIG. 7 disclose a flow chart of the step of applying the thermoplastic adhesive in the ferrule.

### DETAILED DESCRIPTION

Aspects of the present disclosure will be described more fully hereinafter with reference to the accompanying drawings. Like numbers in the drawings refer to like elements throughout.

The terminology used herein is for the purpose of describing particular aspects of the disclosure only, and is not intended to limit the disclosure. As used herein, the singular forms “a”, “an” and “the” are intended to include the plural forms as well, unless the context clearly indicates otherwise.

In the drawings and specification, there have been disclosed exemplary aspects of the disclosure. However, many variations and modifications can be made to these aspects without substantially departing from the principles of the present disclosure. Thus, the disclosure should be regarded as illustrative rather than restrictive, and not as being limited to the particular aspects discussed above. Accordingly, although specific terms are employed, they are used in a generic and descriptive sense only and not for purposes of limitation, for example, definition of dimensions such as width or breadth or height or length or diameter depends on how exemplary aspects are depicted, hence, if depicted differently, a shown width or diameter in one depiction is a length or thickness in another depiction.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example aspects may be implemented at least in part by means of both hardware and software, and that several “means”, “units” or “devices” may be represented by the same item of hardware.

The different aspects, alternatives and embodiments of the invention disclosed herein can be combined with one or more of the other aspects, alternatives and embodiments described herein. Two or more aspects can be combined.

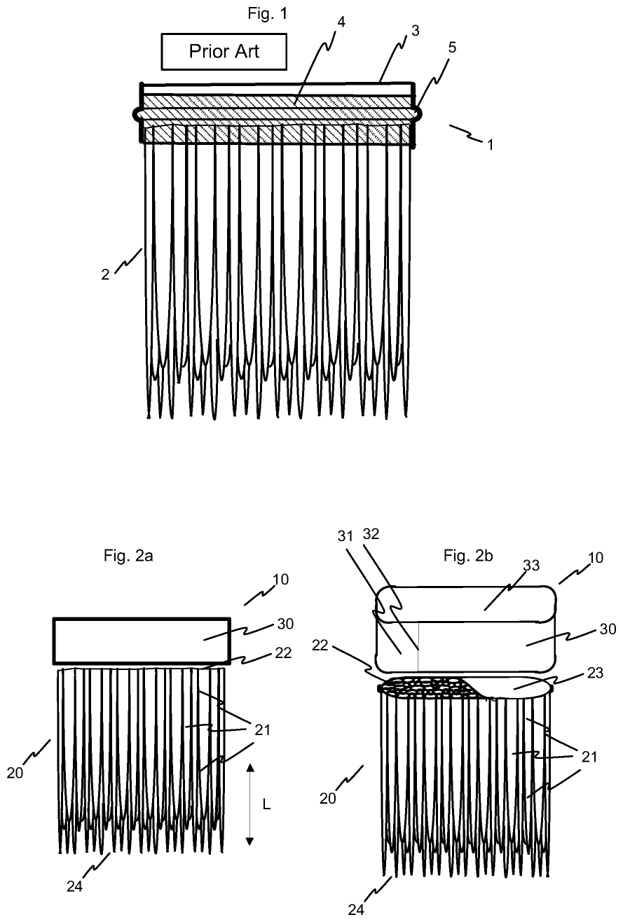

A paint brush head 1 manufactured with an epoxy adhesive in accordance with prior art is disclosed in FIG. 1. The paint brush head 1 comprise a bundle of bristles 2, a ferrule 3 and a cured epoxy adhesive 4. The ferrule 3 comprise a groove 5. When manufacturing this paint brush head 1 according to prior art, one end of the bundle of bristles 2 is inserted into the ferrule 3. Thereafter an uncured epoxy adhesive is poured into the ferrule 3 onto the ends of the bristles in the bundle of bristles 2. The uncured epoxy adhesive is thereafter cured. During curing the uncured epoxy adhesive penetrates a distance into the one end of bundle of bristles 2 and connects the bristles in the bundle of bristles 2 towards each other when it its cured. A part of the uncured epoxy adhesive lies on top of the bundle of bristles 2 and floats into the groove 5 of the ferrule 3 and when the epoxy adhesive is cured it mechanically connects the cured epoxy adhesive 4 in the groove 5. As the cured adhesive 4 is connected to the bundle of bristles 2, the bundle of bristles 2 is mechanically connected to the ferrule 2 via the cured epoxy adhesive 4 and the groove 5.

The invention relates to a method for manufacturing a paint brush head and will now be further described in relation to FIGS. 2-7.

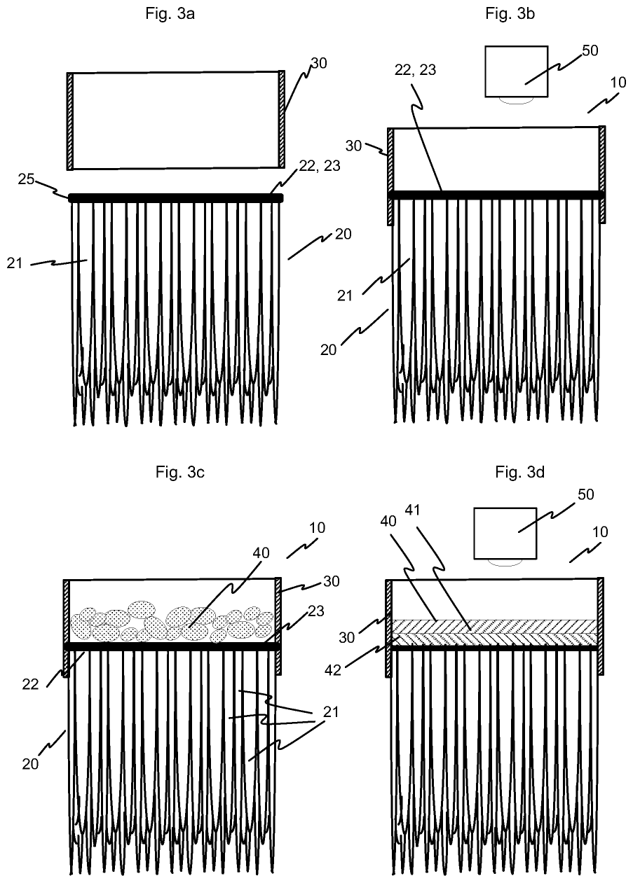

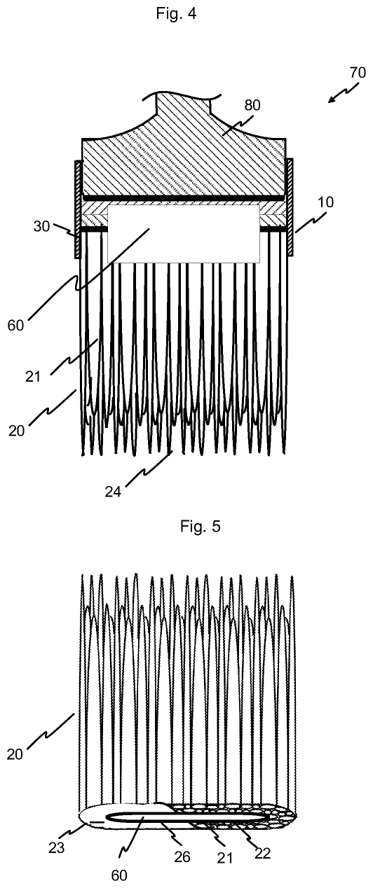

In FIGS. 2 and 3 a bundle of bristles 20 and a ferrule 30 according to an aspect of the invention is disclosed.

The bundle of bristles 20 comprise a number of bristles 21. At least some of the bristles 21 are synthetic bristles 21. According to an aspect, all of the bristled 21 are synthetic bristles.

As illustrated by FIGS. 2 and 3, the bundle of bristles 20 may comprise different types of bristles 21 having different lengths and/or diameters and/or materials. Alternatively, the bundle 21 of bristles 20 may comprise only one type of bristles having the same length, diameter and/or material. The bristles 21 have a first end 21 and a second end 24.

In the context of the present invention under the term “bristle” there is understood an elongated flexible body having the first end 22 and the second end 24, i.e. a bristle/monofilament. The first end 22 is part of a root section where the bristle 21 is configured to be contained in, held/mounted and/or fastened in the ferrule 30. The second end 24 of the bristle 21 forms a free tip, which usually contacts a surface to be coated with paint. The second end 24 is part of the tip section of the bristle/monofilament.

The bundle of bristles 20 in accordance to an aspect comprise solid and/or hollow bristles 21 and have a wide variety of cross-sections, including circular, oval, triangular, trilocular, tetralocular, lobate, etc., and/or may be corrugated, contain multiple voids or have any other type of uneven surface.

The bristles 21 may be made from any suitable thermoplastic polymer, including polyamides, polyesters, polyolefins, polypropen or a mix thereof.

The bristles in the bundle of bristles 20 may be a mix of different types of bristles, e.g. having different lengths and/or different diameters and/or be made of different materials. By “diameter” throughout this application is meant the average diameter of the bristle 21 or in general the maximum cross-sectional dimension of the bristle or monofilament.

Methods of mixing, forming and gathering individual bristles or monofilaments into a plurality of such ones in a bundle or tuft of bristles before connecting/fixing/attaching/joining the bristles to each other at one end as such are known in the art and not explained further here.

The bundle of bristles 20 in accordance to an aspect comprise an insert 60, as disclosed in FIGS. 4 and 5. The bundle of bristles 20 in according to an aspect comprise two or more inserts 60. The insert 60 is used in the bundle of bristles 20 for separating the bristles 21 and creating voids in the bundle of bristles 20 for enhancing the paint pick up and release of the paint brush head 10 when it is used for painting. The use of inserts as such is known in the art and will not be described further herein.

The insert 60 may be made from any suitable thermoplastic polymer, including polyamides, polyesters, polyolefins, polypropen or a mix thereof.

The ferrule 30 is a ring shaped object that is used for holding the bristles 21 in the bundle of bristles 20 and to connect the bundle of bristles 20 to a paint brush handle 60. A ferrule 30 as such is known in the art and will thus not be described in detail herein. According to an aspect, the ferrule 30 comprise a band 31 that is jointed in its ends at a joint 32. According to an aspect, the ferrule 30 is made of metal, such as steel, stainless steel or aluminium. According to an aspect the ferrule 30 is made of a thermoplastic material, such as polyamides, polyolefins polyester, polypropen, ppt or nylon or a mix thereof. According to an aspect the ferrule 30 is made of a heat resistant material, such as a carbon fibre or glassfiber reinforced composite.

According to an aspect at least a part of an inside 33 of the ferrule 30 comprise roughened surface. According to an aspect the roughened surface is achieved by scoaring and/or pickling the at least part of the inside 33 of the ferrule 30. The roughened surface has a larger surface area than an even surface.

According to an aspect the ferrule 30 comprise one or more grooves on the inside 33 of the ferrule 30. According to an aspect the groove is an annular groove that runs along the inside 33 of the ferrule 30.

Hereafter the method of manufacturing the paint brush head 10 comprising one bundle of bristles 20 comprising synthetic bristles 21 and one ferrule 30 with reference to FIG. 3a-3d and FIGS. 4 and 5. The paint brush head 10 is disclosed in the different FIG. 3a-3d after different steps in of the method.

To manufacture the paint brush head 10 a number of bristles 21 is gathered S1 into a group of bristles so that the bristles 10 are tangent to each other all along their length L. The number of bristles 21 is dependent on the type and size of the actual paint brush head 10 that should be manufactured. The bristles 21 of the bundle of bristles 20 are aligned S2 so that the first end 21 of the bristles 21 make up a flush end surface 23. The bundle of bristles 21 are according to an aspect shaped into a shape having a predefined outer periphery corresponding to the desired shape of the paint brush head 10.

The first ends 22 of the bristles 21 is arranged S3 in the ferrule 30, as can be seen in FIG. 3b. As the bristles is arranged in the ferrule 30 the bundle of bristles 20 is arranged in the ferrule 30 and could be moved as one unit. However, if any force is applied to the bristles 21, the bristles 21 could rather easy be removed from the bundle of bristles 20.

According to an aspect at least a part of an inside 31 of the ferrule 30 roughening before the step of arranging S3 the first end of the bristles 21 in the ferrule 30. According to an aspect the step of roughening S7 at least a part of an inside 31 of the ferrule 30 comprise scoaring and/or pickling the at least part of the inside of the ferrule 30.

According to an aspect at least one groove 31 is made S8 on at least a part of inside 31 of the ferrule 30 before the step of arranging S3 the first end 22 of the bristles 21 in the ferrule 30.

A thermoplastic adhesive 40 is applied S4 in the ferrule 30 at the flush end surface 23 of the bundle of bristles 20, as is disclosed in FIG. 3c. Put in another way, the thermoplastic adhesive 40 is applied into the ferrule 30 and lies on the flush end surface 23 of the bundle of bristles 20. According to an aspect the step of applying S4 the thermoplastic adhesive 40 at the flush end surface 23 in the ferrule 30 comprise melting S41 the thermoplastic adhesive 40 and thereafter pouring S42 it in the ferrule 30 on to the flush end surface 23. According to an aspect the step of applying S4 the thermoplastic adhesive 40 on the flush end surface 23 in the ferrule 30 comprise applying S43 the thermoplastic adhesive 40 in a fixed state in the ferrule 30 on to the flush end surface 23. According to an aspect the fixed state of the thermoplastic adhesive 40 is granulates (as is disclosed in FIG. 3c), powder or a mixture thereof.

According to an aspect the step of applying S4 the thermoplastic adhesive 40 on the flush end surface 23 in the ferrule 30 comprise applying S43 the thermoplastic adhesive 40 in a heated and melted state in the ferrule 30 on to the flush end surface 23.

The first ends 22 of the bristles 21 in the bundle of bristles 20 is fused S5 together by means of heat. According to an aspect the first ends 22 of the bristles 21 in the bundle of bristles 20 is fused together by means of a laser 50. According to an aspect the step of fusing S5 the first ends 22 of the bristles 21 at the flush end surface 23 together comprise fusing S51 the first ends 22 of the bristles 21 at the flush end surface 23 by a laser 50 into a jointed bundle of bristles 23.

By fusing S4, the first ends 22 of the bristles 21 in the bundle of bristles 20, the flush end surface 23 becomes a continuous layer 25 of melted and jointed bristles 21. According to an aspect the first ends 22 of the bristles 21 in the bundle of bristles 20 is fused together by means of a IR-irradiation or a direct heat source in contact with the bristles 21 so that the flush end surface 23 becomes a continuous layer 25 of melted and jointed bristles 21.

According to an aspect the step of fusing S5, S51 the first ends 22 of the bristles 21 at the flush end surface 23 together by heat into a jointed bundle of bristles 20 is made before the step of arranging S3 the first end 22 of the bristles 21 in the ferrule 30 and/or the step of applying S4 the thermoplastic adhesive 40 on the flush end surface 23 in the ferrule 30.

The thermoplastic adhesive 40 in the ferrule 30 is fused S6 by means of the laser 50 to connect the thermoplastic adhesive 40 to the jointed bundle of bristles 23 and the ferrule 30. By fusing the thermoplastic adhesive 40 by the laser 50 the thermoplastic adhesive 40 adheres to both the ferrule 30 and to the bundle of bristles 20 such that the paint brush head 10 is one unit strong unit. According to an aspect the thermoplastic adhesive 40 and the continuous layer 25 of melted and jointed bristles 21 is mixed in a zone where they meet.

According to an aspect the step of fusing S6 the thermoplastic adhesive 40 in the ferrule 30 by means of the laser 50 to connect the thermoplastic adhesive 40 to the jointed bundle of bristles 20 and the ferrule 30 comprise heating S61 the thermoplastic adhesive 40 by means of the laser 50 to a temperature higher than its service temperature. By service temperature is meant the temperature for a specific thermoplastic adhesive 40 that it is intended to be used when heated by a heat source and poured/applied to a surface. The service temperature of a thermoplastic adhesive is often defined by the supplier of the thermoplastic adhesive and is an indication of at which temperature the thermoplastic adhesive should be used to have the intended effect. The service temperature according to aspects are called application temperature. The application temperature is specified by the manufacturer of the thermoplastic adhesive and is an instruction to the user for at which temperature the thermoplastic adhesive should be applied at.

According to an aspect the step of fusing S6 the thermoplastic adhesive 40 in the ferrule 30 by means of the laser 50 to connect the thermoplastic adhesive 40 to the jointed bundle of bristles 20 and the ferrule 30 comprise heating 62 the thermoplastic adhesive 40 by means of the laser 50 to a temperature that is 10-90% higher than its service temperature, preferably 20-80% higher than its service temperature and more preferably 30-80% higher than its service temperature. According to an example a thermoplastic adhesive 40 with an indicated service temperature of 150-180° C. where used and it was fused to a temperature of 250 C.° by the laser 50. When the thermoplastic adhesive 40 is heated above the service temperature it will get a lower viscosity than at the service temperature and adhere better to the ferrule 30.

According to an aspect the step of fusing S6 the thermoplastic adhesive 40 in the ferrule 30 by means of the laser 50 to connect the thermoplastic adhesive 40 to the jointed bundle of bristles 20 and the ferrule 30 comprise heating S63 the thermoplastic adhesive 40 by means of the laser 50 to a temperature above its boiling temperature.

According to an aspect the step of fusing S5, S51 the first ends 22 of the bristles 21 at the flush end surface 23 together by means of the laser 50 into a jointed bundle of bristles 20 and the step of fusing S6 the thermoplastic adhesive 40 in the ferrule 30 by means of the laser 50 to connect the thermoplastic adhesive 40 to the jointed bundle of bristles 20 and the ferrule 40 is made in one combined step.

According to an aspect the two steps of fusing S5, S51, S6 is performed by means of one laser 50. According to an aspect the two steps of fusing S5, S51, S6 is performed by means of two lasers 50, one laser 50 that is fusing S5, S51 the first ends 22 of the bristles 21 at the flush end surface 23 together and another laser 50 is fusing S6 the thermoplastic adhesive 40 in the ferrule 30.

According to an aspect the ferrule 30 is heated S10 to a temperature between 30°-90° degrees before arranging S3 the first end 22 of the bristles 21 in the ferrule 30. This will prolong the time that the thermoplastic adhesive 40 will have a low viscosity in the area where it adheres to the ferrule 30 and thus adhere better to the ferrule 30.

According to an aspect the thermoplastic adhesive 40 is melted in the ferrule 30 by means of a laser before the step of fusing S6 the thermoplastic adhesive 40 in the ferrule 30 by means of the laser 50 to connect the thermoplastic adhesive 40 to the jointed bundle of bristles 21 and the ferrule 30.

According to an aspect the thermoplastic adhesive 40 is a hot melt adhesive or hot glue.

The colour and the transparency of the thermoplastic adhesive 40 have an impact on how the energy from the laser 50 is transferred from the laser 50 to the thermoplastic adhesive 10 and to the bristles 21. According to an aspect thermoplastic adhesive 40 of different colour is used based on if the two steps of fusing S5, S51, S6 is made simultaneously or after one another. According to an aspect the thermoplastic adhesive 40 are transparent, which will increase the energy from the laser 50 to heat the thermoplastic adhesive 40 and at the same time heat the first ends 22 of the bristles 21.

According to an aspect one or more inserts 60 are arranged S9 in the bundle of bristle 20.

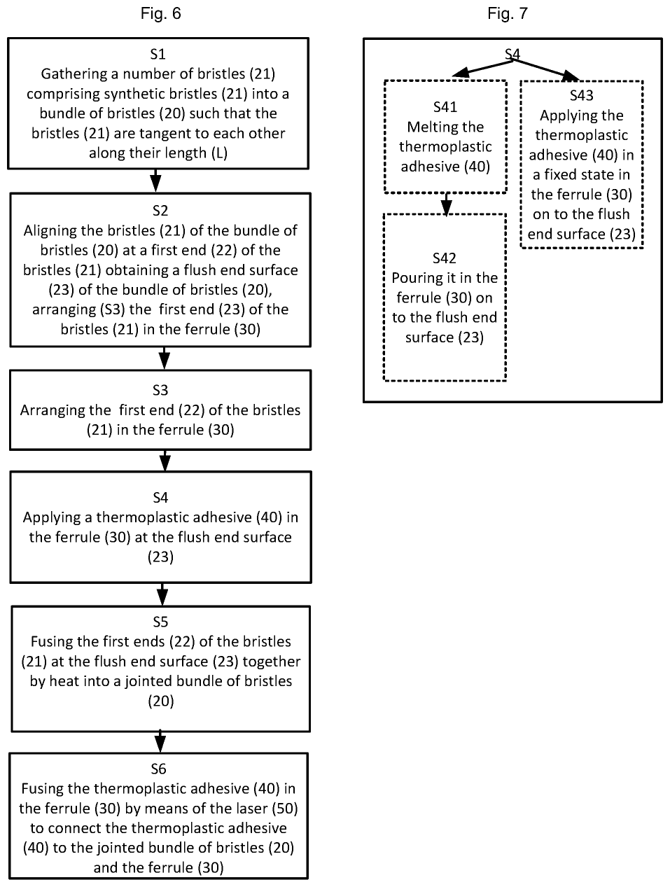

Referring to FIG. 3d, a paint brush head 10 according to an aspect of the invention is disclosed wherein the paint brush head 30 comprises a bundle of bristles 20 obtained by the method steps shown in FIG. 6.

The ferrule 30 may comprise grooves, ridges or other suitable connection means 32 configured for fixing or detachable attaching the paint brush head 10 to a paint brush handle 80, as shown in FIG. 4.

Referring to FIGS. 5 and 6, a bundle 20 of bristles 10 comprising an insert 60 and a paint brush 40 comprising such bundle of bristles 20 according to the invention is illustrated, wherein the insert 60 is placed at the one end of the bristles 10 and extends along part of the length of the bristles 10. The insert 60 is arranged such that the bristles 10 encircle the insert 60. An end surface of the polymer insert 60 and the one end 22 of the bristles 21 may together make up the flush end surface 23 of the bundle 20 of bristles 10. According to an aspect the insert 60 is a polymer insert 60. When fusing the bristles 21 to for example an outer periphery of the polymer insert 60, a weld line 34 may be created between the polymer insert 60 and the adjacent bristles 21. Here, the bundle of bristles 20 forms an annular shaped volume around the insert 60 and between the polymer insert and the (polymer) bristle carrier or ferrule 30. According to an aspect the bundle of bristle 20 comprise two or more inserts 60

As shown in FIG. 6 the insert 60 may extend a distance along the length of the bristles 21 corresponding to the length the (polymer) ferrule 30 extends along the length of the bristles 21.

The step of gathering S1 and aligning S2 is according to an aspect performed simultaneously in one and the same step. The step of gathering S1 and aligning S2 is according to an aspect performed is performed as separate steps one after the other.

The step of fusing S5 the first ends 22 of the bristles 21 at the flush end surface 23 together is according to an aspect performed before the step of arranging S3 the first end 22 of the bristles 21 in the ferrule. The step of fusing S5 the first ends 22 of the bristles 21 at the flush end surface 23 together is according to an aspect performed after the step of arranging S3 the first end 22 of the bristles 21 in the ferrule.

The step of fusing S5 the first ends 22 of the bristles 21 at the flush end surface 23 together is according to an aspect performed before the step of arranging S3 the first end 22 of the bristles 21 in the ferrule and after the step of applying S4 the thermoplastic adhesive 40 in the ferrule 30 at the flush end surface 23.

The energy applied by the laser 50 in the step fusing S5 the first ends 22 of the bristles 21 at the flush end surface 23 together is according to an aspect sufficient to melt the first end 22 of the bundle of bristles 20 together and to provide a strong and at the same time flexible or supple or soft smelt/fuse when fusing S5 the first end 22 of the plurality of bristles 21 together, whereas the temperature is kept at an optimised level as a too high temperature during the fusing S5 may provide a porous and brittle smelt or fuse.

According to an aspect the energy from the laser 50 is in the step of fusing S5 applied in one or more steps. In a first step the first end 22 of the bristle 21 are preheated, in a second step the first end 22 of the bristle 21 are starting to melt and in a third step the first end 22 of the bristle 21 are completely melted. According to one aspect the three steps are performed as one step. In one or more of the first, second and third step the energy from the laser is applied during a predetermined time.

The energy applied by the laser 50 in the step of fusing S6 thermoplastic adhesive 40 in the ferrule 30 by means of the laser 50 is according to an aspect sufficient to melt the thermoplastic adhesive 40 to connect the jointed bundle of bristles 20 and the ferrule 30 together and to provide a strong and at the same time flexible or supple or soft smelt/fuse.

The energy applied by the laser 50 in the step of fusing S6 thermoplastic adhesive 40 in the ferrule 30 by means of the laser 50 is according to an aspect sufficient to melt the thermoplastic adhesive 40 to connect the jointed bundle of bristles 20 and the ferrule 30 together and to melt the first end 22 of the bundle of bristles 20 again such that the thermoplastic adhesive 40 mixes/fuses with the first end 22 of the bundle of bristles 20.

According to an aspect the energy from the laser 50 in the step of fusing S6 is applied in one or more steps. In a first step, the thermoplastic adhesive 40 is heated by the laser to a temperature within the range of the service temperature of the thermoplastic adhesive 40 and in a second step the thermoplastic adhesive 40 is heated to a temperature above the service temperature. In the first step the thermoplastic adhesive 40 melts and transitions from its fixed state to a melted state. In the melted state the granulates or powder is transferred from being separate parts to become one and the same and the thermoplastic adhesive know floats on top of the bundle of bristles 20 in the ferrule 30. In the second state, the thermoplastic adhesive 40 is heated above its service temperature and the increased temperature lowers the viscosity of the thermoplastic adhesive 40.

According to one aspect the two steps are performed as one-step. According to one aspect the two steps are performed as different steps and in some cases even at different times during the manufacturing of the paint brush head 10.

According to an aspect the step of applying S4 the thermoplastic adhesive 40 in the ferrule 30 at the flush end surface 23 is made after the step of fusing S5 the first ends 22 of the bristles 21 at the flush end surface 23 together by heat into a jointed bundle of bristles 20.

The viscosity of the thermoplastic adhesive 40 is temperature dependent, higher temperature lowers viscosity. The viscosity influences the spread of applied thermoplastic adhesive 40 in the ferrule 30. The low viscosity of the thermoplastic adhesive 40 makes the adherence between the ferrule 30 and the thermoplastic adhesive 40 good. The thermoplastic adhesive 40 adheres to the ferrule 30. In one or more of the first and second step, the energy from the laser is applied during a predetermined time. The time that the energy is applied during the second step should be kept as short as possible to avoid that the thermoplastic adhesive 40 becomes brittle and charred as it cools. The applicant has realised by that by heating the thermoplastic adhesive 40 by means of the laser 50 in the step of fusing the thermoplastic adhesive 40 in the ferrule 30 to connect the thermoplastic adhesive 40 to the jointed bundle of bristles 20, the energy from laser 50 heats the thermoplastic adhesive 40 to the temperature above the service temperature during such a short time that the low viscosity is achieved without the thermoplastic adhesive becomes brittle as it cools, gets charred or even catches fire. The applicant has also realised that by heating the thermoplastic adhesive 40 in the ferrule 30, the time needed for the thermoplastic adhesive 40 to be above the service temperature is reduced as it already is in the position next to the things that it should adhere to. According to an aspect the time needed is less than 60 seconds. According to an aspect the time needed is less than 30 seconds. According to an aspect the time needed is less than 10 seconds.

Referring to FIG. 5, a bundle of bristles 20 according to an aspect is disclosed. The bundle of bristles 20 comprise an insert 60 arranged such that a portion of the insert 60 protrudes form the end surface 23 of the plurality of bristles 10. As shown on FIG. 5 the protruding portion of the insert 60 may be melted by means of the laser 50 into a fusing layer 26 covering the end surface 23 of the plurality of bristles 21 during the step of fusing S5.

The bundle of bristles 20 and the insert 60 in accordance to this aspect be fused together in one method step. The protruding portion of the polymer insert 60 may be melted by means of the laser 50.

According to an aspect the ferrule 30 have a conical shape, such that it can interact with the bundle of bristles 20. The bundle of bristles 20 that has been fused S5 is according to an aspect mechanically locked to the ferrule 30 when the first end 22 of the bristles 21 in bundle of bristles 20 is arranged S4 in the ferrule 30. According to an aspect the conical ferrule 30 comprise one or more grooves according to the above and a peripheral edge of the fusing layer 26 covering the end surface 23 of the plurality of bristles 10 is configured to snap into the grooves as the bristles 20 is arranged S4 in the ferrule 30.

In FIG. 4, a paint brush 70 according to an aspect of the invention is disclosed. The paint brush 70 comprise a paint brush head 10 according to the above and a paint brush handle 80. The paint brush handle 80 is connected to the paint brush head 10. According to an aspect the paint brush handle 80 is connected to the paint brush head 10 by nails, friction, glue, fusing, a mechanical lock or any combination thereof.

According to an aspect the paint brush 80 comprise an insert 60 in accordance to the above.

The insert 60 may be of a equilateral shape such that it is correctly orientated before and during the fusing process and does not end up askew relative to the surrounding parts making up the inventive paint brush and paint brush head.

According to an aspect the method of manufacturing is used to produce other types of brushes, such as make-up brushes, that comprise a ferrule 30 and a bundle of bristles 20.

In the drawings and specification, there have been disclosed exemplary embodiments. However, many variations and modifications can be made to these embodiments. Accordingly, although specific terms are employed, they are used in a generic and descriptive sense only and not for purposes of limitation, the scope of the embodiments being defined by the following claims.

1. A method of manufacturing a paint brush head comprising a bundle of bristles comprising synthetic bristles and a ferrule, the method comprising:
gathering a number of bristles comprising synthetic bristles into a bundle of bristles such that the bristles are tangent to each other along their length,
aligning (S2) the bristles of the bundle of bristles at a first end of the bristles obtaining a flush end surface of the bundle of bristles,
arranging the first end of the bristles in the ferrule,
applying a thermoplastic adhesive in the ferrule at the flush end surface,
fusing the first ends of the bristles at the flush end surface together by heat into a jointed bundle of bristles, and
fusing the thermoplastic adhesive in the ferrule by a laser to connect the thermoplastic adhesive to the jointed bundle of bristles and the ferrule.

2. The method in accordance with claim 1, wherein the step of applying the thermoplastic adhesive at the flush end surface in the ferrule comprise melting the thermoplastic adhesive and thereafter pouring it in the ferrule on to the flush end surface.

3. The method in accordance with claim 1, wherein the step of applying the thermoplastic adhesive on the flush end surface in the ferrule comprise applying the thermoplastic adhesive in a fixed state in the ferrule on to the flush end surface.

4. The method accordance with claim 3, wherein the fixed state of the thermoplastic adhesive is granulates, powder or a mixture thereof.

5. The method according to claim 1, wherein the step of fusing the thermoplastic adhesive in the ferrule by the laser to connect the thermoplastic adhesive to the jointed bundle of bristles and the ferrule comprise heating the thermoplastic adhesive by the laser to a temperature higher than its service temperature.

6. The method according to claim 1, wherein the step of fusing the thermoplastic adhesive in the ferrule by the laser to connect the thermoplastic adhesive to the jointed bundle of bristles and the ferrule comprise heating the thermoplastic adhesive by the laser to a temperature that is 10-90% higher than its service temperature.

7. The method according to claim 1, wherein the step of fusing the thermoplastic adhesive in the ferrule by the laser to connect the thermoplastic adhesive to the jointed bundle of bristles and the ferrule comprise heating the thermoplastic adhesive by the laser to a temperature above its boiling temperature.

8. The method according to claim 1, comprising the step of roughening at least a part of an inside of the ferrule before the step of arranging the first end of the bristles in the ferrule.

9. The method according to claim 8, wherein the step of roughening at least a part of an inside of the ferrule comprise scoaring and/or pickling the at least part of the inside of the ferrule.

10. The method according to claim 1, comprising the step of making a groove on at least a part of an inside of the ferrule before the step of arranging the first end of the bristles in the ferrule.

11. The method according to claim 1, wherein the thermoplastic adhesive is a hot melt adhesive or hot glue.

12. The method according to claim 1, wherein the step of fusing the first ends of the bristles at the flush end surface together comprise fusing the first ends of the bristles at the flush end surface by a laser into a jointed bundle of bristles.

13. The method according to claim 12, wherein the step of fusing the first ends of the bristles at the flush end surface together by the laser into a jointed bundle of bristles and the step of fusing the thermoplastic adhesive in the ferrule by the laser to connect the thermoplastic adhesive to the jointed bundle of bristles and the ferrule is made in one combined step.

14. The method according to claim 1, wherein fusing the first ends of the bristles at the flush end surface together by heat into a jointed bundle of bristles is made before the step of arranging the first end of the bristles in the ferrule.

15. The method according to claim 1, comprising arranging one or more inserts in the bundle of bristles.

16. The method according to claim 1, wherein the ferrule is made of metal, such as steel, stainless steel or aluminium.

17. The method according to claim 1, wherein the ferrule is made of a thermoplastic material, such as polyamides, polyolefins, polyester, polypropen or a mix thereof.

18. The method according to claim 1, wherein the ferrule is made of a heat resistant material, such as a carbon fibre or glass fibre reinforced composite.

19. The method according to claim 1, wherein the plurality of bristles and/or polymer insert is/are made of a thermoplastic material, such as polyamides, polyolefins, polyester, polypropen or a mix thereof.

20. The method according to claim 1, wherein the ferrule is heated to a temperature between 30°-90° degrees before arranging the first end of the bristles in the ferrule.

21. The method according to claim 1, further comprising the step of melting the thermoplastic adhesive in the ferrule by a laser before the step of fusing the thermoplastic adhesive in the ferrule by the laser to connect the thermoplastic adhesive to the jointed bundle of bristles and the ferrule.

22. A paint brush head comprising a bundle of bristles and a ferrule manufactured by the method according to claim 1.

23. A paint brush comprising a paint brush head according to claim 22 attached to a paint brush handle.
